(19) United States
(12) Patent Application Publication
(10) Pub. No.: US 2003/0079594 A1
(43) Pub. Date: May 1, 2003

(54) Band-steel tool

(76) Inventor: Horst Kemper, Leverkusen (DE)

Correspondence Address: COLLARD & ROE, P.C., 1077 Northern Boulevard, Roslyn, NY, 11576-1696, US

(21) Appl. No.: 10/264,414

(22) Filed: Oct. 4, 2002

(30) Foreign Application Priority Data
Oct. 6, 2001 (DE) 101 49 351.7

(51) Int. Cl. B26D 1/01

(52) U.S. Cl. 83/698.31; 83/699.11

(57) ABSTRACT

A band-steel tool with a plate in which band-shaped punching blades are held, which are bent in accordance with a pre-determined cutting shape. The plate is structured as a sandwich plate that has at least one elastomer intermediate layer sandwiched between two shape-stable cover plates. The punching blades are inserted into slits in the cover plates and the intermediate layer. The intermediate layer is elastically deformed by being sandwiched in place, and thereby exerts a clamping effect on the punching blades.

### BACKGROUND

The invention relates to a band-steel tool with a plate, in which band-shaped punching blades are held. The blades are bent in accordance with a pre-determined cutting shape. The band-steel tool is particularly suitable for punching out pre-forms for folded boxes, labels, puzzles, or similar parts made of paperboard, leather, or other soft, flat materials.

In practice, the plate of the band-steel tool consists of wood, and has slits to hold the band-shaped punching blades. The slits are produced by laser cutting. The punching blades are fitted into the slits with a pressure fit. Replacement of dull punching blades is not possible, or only possible with difficulty, since the wood frequently breaks out when the punching blades are replaced.

A band-steel tool known from DE 93 03 160 U1 has a plastic plate produced from a cast resin, into which the band-shaped punching blades are cast. To improve its rigidity, the plastic plate have crosswise stays or can be reinforced by inserts made of wire mesh or woven fiber fabric. Replacement of dull blades is not possible.

The invention provides a band-steel tool having punching blades that are not only precisely fixed in place, but can also be replaced.

### SUMMARY

According to the invention, the plate is structured as a sandwich plate that has at least one elastomer intermediate layer sandwiched in place between two shape-stable cover plates. The punching blades are inserted into slits in the cover plates and the intermediate layer. The intermediate layer is elastically deformed by being sandwiched between the two cover plates, and thereby exerts a clamping effect on the punching blades.

The band-shaped punching blades are fitted precisely into the slits of the cover plates and also pass through corresponding contours of the intermediate layer. During assembly of the punching blades the intermediate layer is not yet deformed and is not yet clamped or sandwiched. After the punching blades have been inserted into the sandwich plate, the cover plates are sandwiched against one another compressing the intermediate layer. As it is compressed, the intermediate layer expands in area and exerts a clamping effect on the punching blades. Because of the clamping effect of the elastically deformed intermediate layer, the band-shaped punching blades are rigidly held in place in the sandwich plate. After the connections are removed, the elastomer intermediate layer returns to its original shape, eliminating the clamping effect on the punching blades, and allowing the punching blades to be replaced.

In accordance with a preferred embodiment of the invention, the cover plates are sandwiched against one another by means of a multiplicity of screw connections distributed over the plate surface. Furthermore, spacer elements are arranged between the cover plates defining the connecting path. The cover plates are sandwiched against one another until they make contact with the spacer elements. This ensures uniform and defined deformation of the elastomer intermediate layer. In a preferred embodiment the spacer elements are sleeves through which the bolts of the screw connections pass.

The cover plates can be made of wood, metal, or plastic. Cover plates made of metal are preferred, particularly aluminum or an aluminum alloy. The slits for the punching blades are produced by means of a water-jet cutting technology, laser technology, or similar methods. The intermediate layer preferably consists of rubber or rubber-like material, such as a synthetic rubber.

In another embodiment, the invention has alternately arranged elastomer intermediate layers and shape-stable plates. The intermediate layers are deformable by sandwiching the outer cover plates. Spacer elements are arranged between the shape-stable plates to limit the compression of the intermediate layers. The band-shaped punching blades are fixed in place via block bracing. The cover plates and the shape-stable plates, with the spacer elements between them, are pressed together to form a body with a rigid shape. The band-shaped punching blades are fixed in place in the deformed elastomer intermediate layers.

In a preferred embodiment of the invention, the punching blades are narrower in the region of the elastomer layer. This improves the clamping effect.

In another embodiment the sandwich plate has free-cut fields for embossing matrices that are attached at the back cover plate which is a metal plate.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 is a lengthwise cross-sectional view through a band-steel tool;

FIG. 2 is a lengthwise cross-sectional view through a second embodiment of a band-steel tool; and

FIG. 3 is a lengthwise cross-sectional view through a third embodiment of a band-steel tool.

### DETAILED DESCRIPTION

Referring to the drawings, FIG. 1 shows a band-steel tool that has a plate 1 in which band-shaped punching blades 2 are held and bent in accordance with a pre-determined cutting shape. Plate 1 is structured as a sandwich plate, which has at least one elastomer intermediate layer 4 sandwiched between two shape-stable cover plates 3. Punching blades 2 are placed into slits in cover plates 3 and intermediate layer 4. Intermediate layer 4 is elastically deformed as a result of the compression, and thereby exerts a clamping effect on punching blades 2. The sandwiching of cover plates 3 is achieved by a multiplicity of screw connections 5 distributed over the plate surface. Other types of connections are not intended to be precluded. Screw connections preferably surround the slits. Furthermore, spacer elements 6, in the shape of sleeves, are arranged between cover plates 3 and define a connecting path. This permits defined clamping forces to be exerted on punching blades 2.

Cover plates 3 are made of metal, preferably aluminum or an aluminum alloy. The slits for holding band-shaped punching blades 2 can be accurately produced with a water-jet cutting technology. These slits are equal to or slightly larger than the thickness of punching blades 2 so that punching blades 2 fit snugly within the slits. Further punching blades 2 are equal to or less than the length of the slits so that it may fit within the slit.

Intermediate layer 4 is made of rubber or a rubber-like material. Synthetic rubbers are preferred.

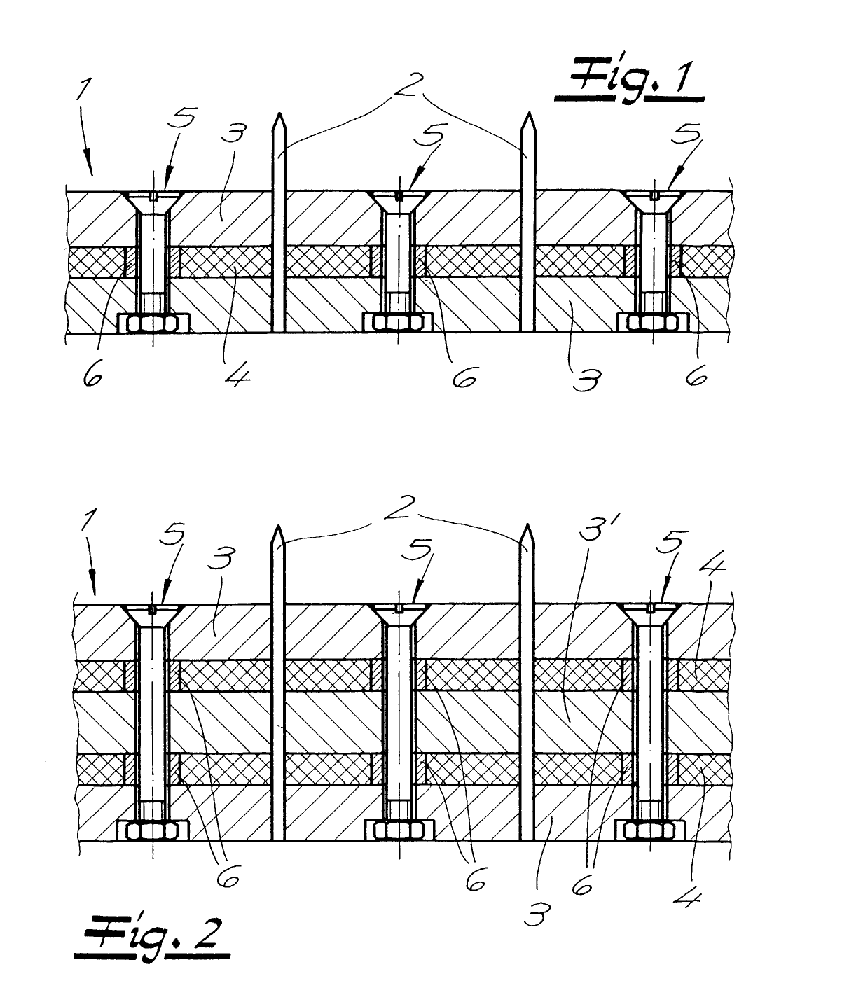

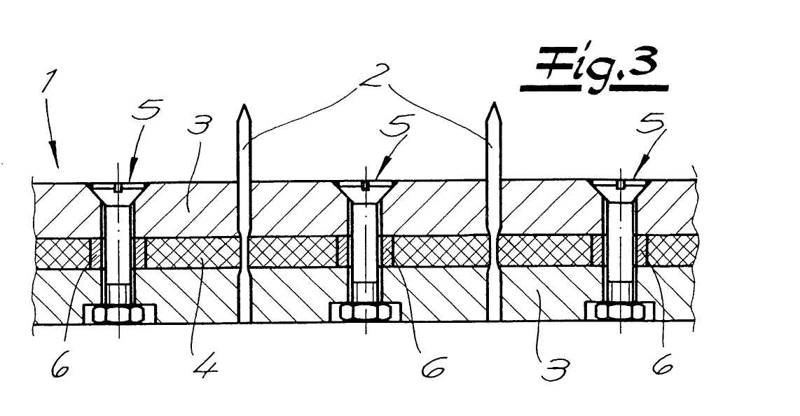

In FIG. 2, plate 1 has intermediate layers 4 and shape-stable cover plates 3, 31 arranged alternately, the intermediate layers are deformable by sandwiching the outer cover plates 3. To limit the compression of intermediate layers 4, spacer elements 6 are arranged between shape-stable plates 3, 3′.

In FIG. 3, punching blades 2 are narrowed or have a lesser thickness in the region of elastomer intermediate layer 4 than in the region of shape-stable plates 3. Because punching blades 2 are narrowed, preferably by 0.2 mm, punching blades 2 have a thickness of 0.7 mm and a better clamping effect.

Accordingly, while several embodiments of the present invention has been shown and described, it is to be understood that many changes and modifications may be made thereunto without departing from the spirit and scope of the invention as defined in the appended claims.

What is claimed is:

1. A band-steel tool plate for receiving at least one band shaped punching blade, said plate comprising:
at least two shape-stable cover plates having at least one slit formed in each plate and in alignment with each other, in accordance with a predetermined cutting shape; and
at least one elastomer intermediate layer disposed between said at least two shape stable cover plates and having at least one slit formed in accordance with the predetermined cutting shape and in alignment with the slits of said cover plates;
wherein the at least one band shaped punching blade is formed in accordance with the predetermined cutting shape of said slits and inserted in said aligned slits of said at least two shape-stable cover plates and said at least one elastomer intermediate layer; and
wherein said at least one elastomer layer is compressed between said at least two shape-stable cover plates causing said at least one elastomer intermediate layer to elastically deform and exert a clamping effect on the at least one band shaped punching blade.

2. The band-steel tool plate according to claim 1, further comprising a plurality of connections distributed over the plate surface and sandwiching said at least two shape-stable cover plates against one another.

3. The band-steel tool plate according to claim 2, further comprising a plurality of spacer elements disposed between said at least two shape-stable cover plates, wherein said plurality of spacer elements define a connecting path.

4. The band-steel tool plate according to claim 3, wherein said plurality of spacer elements comprise sleeves through which bolts of said plurality of connections pass.

5. The band-steel tool plate according to claim 1, wherein said at least two shape stable cover plates are metal plates, and said at least one slit is produced by means of a water-jet cutting technology.

6. The band-steel tool plate according to claim 1, wherein said at least two shape stable cover plates are metal plates, and said at least one slit is produced by means of a laser technology.

7. The band-steel tool plate according to claim 1, wherein said at least two shape stable cover plates are metal plates, and said at least one slit is produced by means of milling.

8. The band-steel tool plate according to claim 1, wherein said at least one intermediate layer is rubber.

9. The band-steel tool plate according to claim 3, wherein the plate has a layer arrangement of alternately arranged elastomer intermediate layers and shape-stable cover plates, and wherein said at least one intermediate layer is deformed by sandwiching said at least two shape-stable cover plates, and said plurality of spacer elements are disposed between said at least two shape-stable cover plates limiting the compression of said at least one elastomer intermediate layer.

10. The band-steel tool plate according to claim 1, wherein the at least one punching blade is narrower in a region inserted in said at least one elastomer intermediate layer.

11. The band-steel tool plate according to claim 1, wherein said plate comprises free-cut fields for embossing matrices that are attached at a back shape-stable cover plate, and wherein said back shape-stable cover plate is metal.
